(19) United States
(12) Patent Application Publication
(10) Pub. No.: US 2013/0088068 A1
(43) Pub. Date: Apr. 11, 2013

(54) Motor-Driven Hub Including an Electric Traction Machine

(71) Applicants: Daniel Walser, Cormerod (CH); Patrick Marro, Givisiez (CH)

(72) Inventors: Daniel Walser, Cormerod (CH); Patrick Marro, Givisiez (CH)

(73) Assignees: Michelin Recherche et Technique S.A., Granges-Paccot (CH); COMPAGNIE GENERALE DES ETABLISSEMENTS MICHELIN, Clermont-Ferrand (FR)

(21) Appl. No.: 13/635,636

(22) PCT Filed: Mar. 17, 2010
(86) PCT No.: PCT/FR10/50475

§ 371 Date: Nov. 9, 2012

(51) Int. Cl. B60K 7/00

(52) U.S. Cl. CPC B60K 7/0007
USPC 301/6.5

(57) ABSTRACT

A motor-driven hub (1) for electrically driving an axle of a motor vehicle, said motor-driven hub including a hub (7) configured to receive a wheel (2), the hub (7) being rotatably mounted with respect to a hub carrier (5) about a hub axis (M), the motor-driven hub including an electric traction machine (3), the electric machine including an external stator (32) connected to the hub carrier and an internal rotor, the rotation of the rotor of the electric machine being permanently coupled to the rotation of the hub by means of reduction means (4), the reduction means (4) including a motor pinion gear (42) connected to the rotor of the electric machine and a crown gear (45) connected to the hub (7), the motor-driven hub also comprising mechanical disk braking means (12), wherein the reduction means include two stages of reduction and the brake disk is placed on the outside of the hub carrier with respect to the vehicle.

This invention concerns the suspension of motor vehicles with electric traction, in particular the motor-driven wheels thereof.

A number of proposals are already known in this field, such as documents EP 0878332, EP 1630026, WO 2006/032669, US 2007/0257570, WO 2007/083209 and WO 2009/124892.

In this application, the expression “motor-driven hub” is used to refer to the mechanical unit comprising the hub, the hub carrier, the guidance of the hub in relation to the hub carrier, the electric motorization and the braking means of the hub. The motor-driven hub is therefore intended firstly to receive a wheel fitted for example with a tire and secondly to bear a vehicle, generally using suspension means. In this application, the expression “motor-driven wheel” is also used to refer to the mechanical unit comprising the motor-driven hub identified above and the corresponding wheel.

One of the difficulties of using such motor-driven hubs on production vehicles is compatibility with solutions already adopted and validated by manufacturers for certain elements, such as suspension systems, wheels and braking devices. Another difficulty is obtaining a compact and simple system that is as light as possible in order to make the related cost acceptable to this industry.

In particular, the integration of electric motors inside motor-driven wheels is particularly desirable because the adoption of electric traction often requires the use of on-board batteries to store the electrical energy which, even with the most efficient technology currently available, requires a sufficient volume to be given over to the batteries on board the vehicle, since failure to do so would significantly reduce the range of an electric vehicle. Similar reasoning can be applied to fuel-cell vehicles and parallel-hybrid vehicles.

The invention is therefore intended to address some or all of these difficulties.

The invention therefore relates to a motor-driven hub for electrically driving an axle of a motor vehicle, said motor-driven hub including a hub designed to receive a wheel, the hub being rotatably mounted with respect to a hub carrier about a hub axis, the motor-driven hub including an electric traction machine, the electric machine including an external stator connected to the hub carrier and an internal rotor, the rotation of the rotor of the electric machine being permanently coupled to the rotation of the hub by means of reduction means, the reduction means including a motor pinion gear connected to the rotor of the electric machine and a crown gear connected to the hub, the motor-driven hub also comprising mechanical disk braking means, the motor-driven hub being characterized in that the reduction means include two stages of reduction and in that the brake disk is placed on the outside of the hub carrier with respect to the vehicle.

Preferably, a first reduction stage involves the meshing of the motor pinion gear and a cog connected to a countershaft, a second reduction stage involving the meshing of a reduction pinion gear connected to the countershaft with the crown gear connected to the hub.

Also preferably, the axis of the countershaft and the axis of the rotor are parallel to the hub axis.

Preferably, the hub carrier includes a spindle about which the hub turns.

Preferably, a casing contains the reduction means and bears the electric machine.

Preferably, the brake disk is placed outside the casing in relation to the vehicle, the brake caliper being rigidly connected to the casing.

The invention also relates to a motor-driven wheel including a motor-driven hub as described above, as well as a vehicle having at least two such motor-driven wheels.

Preferably, two motor-driven wheels are arranged on the rear axle of said vehicle.

Also preferably, the hub carriers of the two motor-driven wheels are each rigidly connected to a trailing arm of the rear axle of said vehicle.

Other characteristics and advantages of the invention are set out in the description of a preferred embodiment. The figures represent respectively:

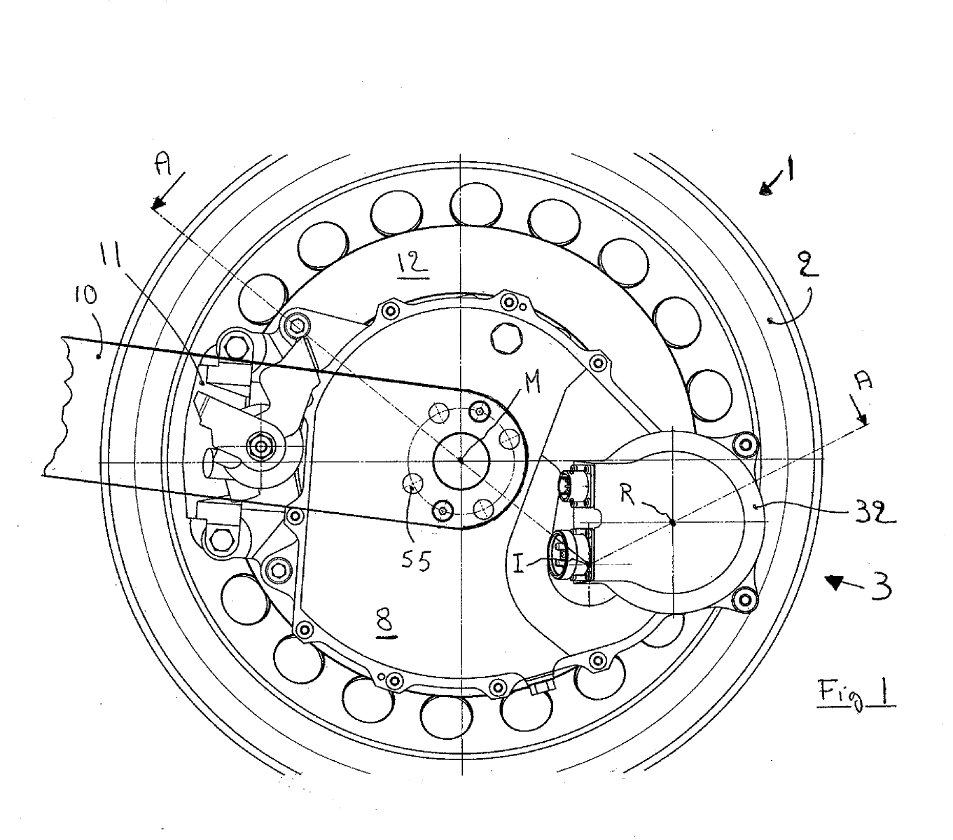

FIG. 1: Plan view along the hub axis from the inside of the vehicle of an embodiment of the motor-driven hub according to the invention.

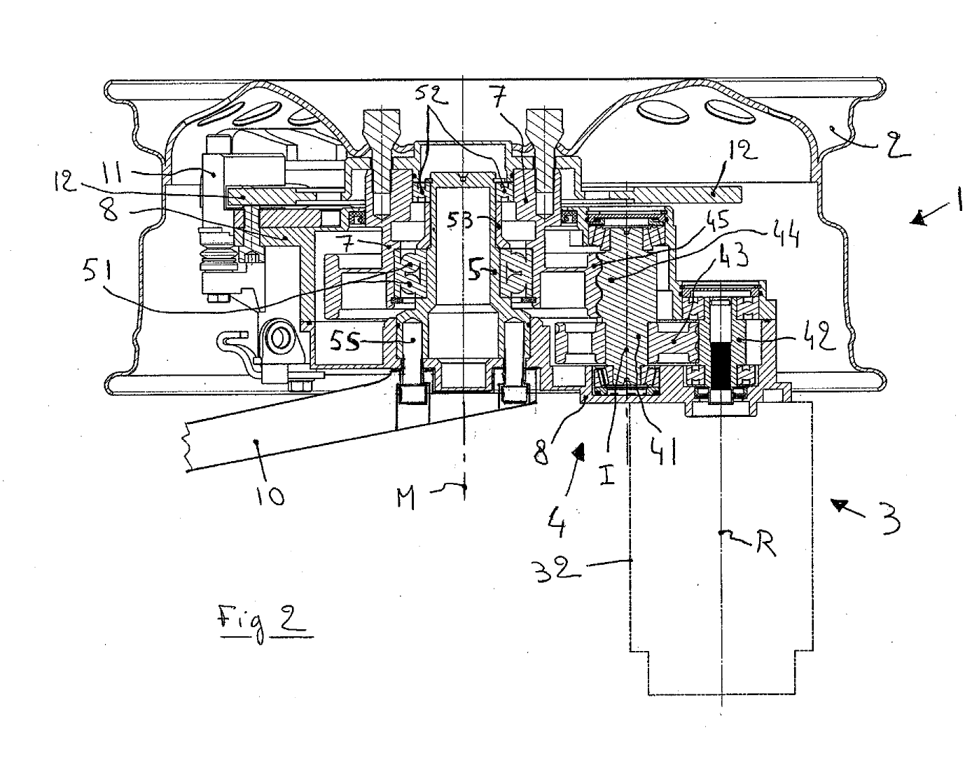

FIG. 2: Cross-section view of this embodiment along the broken line A-A shown in FIG. 1.

Identical or similar elements on the two different figures have the same reference. Consequently, the descriptions thereof are not systematically reproduced.

The figures show an embodiment of a motor-driven wheel according to the invention. The motor-driven hub 1 is intended to guide and control the rotation of a wheel 2. The tire is not shown in the figures. A hub 7, intended to receive the wheel 2, is mounted rotatingly in relation to a hub carrier 5 about a hub axis M.

The hub axis M is a constant reference in this application, and this axis is used as a reference when describing “radial” or “axial” orientation. By way of a reminder and in accordance with established usage in the domain of tires and wheels, axial orientation means orientation parallel to the axis of the hub and radial orientation means orientation perpendicular to the axis of the hub.

An electric machine 3 provides the motorization and where applicable braking of the hub. To simplify the drawing of the electric machine, only the external cover of the stator 32 has been shown. The rotation of the electric machine is permanently coupled to the rotation of the hub via reduction means 4.

An essential characteristic of the motor-driven hub according to the invention is that the reduction means 4 include two stages of reduction. A first reduction stage involves the meshing of the motor pinion gear 42 and a cog 43 connected to a countershaft 41. The motor pinion gear 42 is driven by the shaft of the rotor of the electric machine. A second reduction stage involves the meshing of a reduction pinion gear 44 connected to the countershaft 41 with a hub crown gear 45 connected to the hub 5.

The axis I of the countershaft 41 is preferably, as shown here, parallel to the hub axis M and the axis of rotation R of the rotor. Moreover, the axis of the rotor is preferably, as shown here, removed from the hub axis. The overall reduction ratio is preferably greater than 15.

All of the reduction and guidance means are housed within a casing 8. The casing 8 may also contain a suitable quantity of a lubricant in order to lubricate the unit by splashing.

Another essential characteristic of the motor-driven hub according to the invention is that the braking rotor, i.e. the disk 12, is located outside the hub carrier in relation to the vehicle. As shown in FIG. 2, the brake disk is placed outside the casing 8 on the wheel side, the brake caliper 11 being rigidly connected to the casing.

In this case, the hub carrier is shaped like a spindle extending inside the hub and about which the hub turns, the hub being guided by hub bearings. In this preferred embodiment, this guidance is provided by a main bearing 51 with two rows of balls placed substantially opposite the crown gear 45 and an end bearing 52 with a single row of balls placed substantially opposite the brake disk 12. A spacer 53 separates the two bearings along the spindle 5. The inside of the hub bearings is therefore fixed (rigidly connected to the spindle 5) and the outside turns with the hub 7.

The axis of rotation R of the rotor of the electric machine is removed from the hub axis M and is preferably parallel to it. The stator 32 of the electric machine is connected in rotation to the hub carrier 5. This link, which is required to transmit torque, may be rigid and direct as shown here, but it may also be indirect in order to enable a relative rotational movement in the event of suspension travel. This relative movement must of course be limited and is intended to enable a degree of independence between the torque transmitted and the dynamic rigidities (vertical and horizontal) of the suspension device. In this case, the stator 32 is therefore rigidly connected to the casing 8 while the casing is itself rigidly connected to the hub carrier 5. If a rotation of the casing in relation to the hub carrier is permitted, such rotation may be controlled for example using a connecting rod acting between the casing and the vehicle body (not shown).

The motor-driven hub according to the invention may be attached to the vehicle, more specifically to the suspension system thereof by means of screws engaged in threads 55 of the spindle 5. The casing 8 is therefore clamped between the base of the spindle and the suspension means and is then only bearing the electric machine and the reduction means.

As shown schematically in the figures, the motor-driven hub according to the invention may be attached to the end of the trailing arm 10 of an axle of a vehicle, for example a torsionally flexible rear axle. The front of the vehicle is then to the left of the figures. This preferred embodiment in particular maximizes the space available between the wheels of the vehicle. Naturally, the motor-driven hub according to the invention may also be combined with other types of front or rear suspension systems, such as multi-arm, MacPherson or pseudo-MacPherson systems.

The vehicle according to the invention may be a full electric traction vehicle or a hybrid vehicle. An advantageous way of manufacturing a hybrid vehicle is combining conventional heat motorization of the front axle and electric motorization of the wheels of the rear axle using the motor-driven hubs according to the invention, The source of electrical energy may be a set of batteries or super-condensers, a fuel cell, a trolley bus-style urban network or any other available source of electricity.

The figures show a single electric machine. Naturally, according to the invention, two or more machines may be used for each hub, with each of the machines meshing via its own motor pinion gear with its own or shared reduction means. Multiple motorization may be used to increase the available torque and/or reduce the axial and radial dimensions of the electric machines.

Moreover, a disk brake has been shown systematically. This is the preferred embodiment, but the person skilled in the art knows that, in some situations, it may be preferable to use a drum brake in place of the disk brake.

Regardless of the embodiment of the invention, the reduction means are preferably reversible in order to enable the electric machine to be used in braking mode. The electrical energy recovered by the electric machine in braking mode may be stored or dissipated in a known manner.

One advantage of this invention is that entirely conventional wheels and brakes (disks, calipers), which are therefore relatively cheap to purchase and maintain, may be used.

Although this description focuses on one specific embodiment, the person skilled in the art would be able to envisage other combinations of different means described here with other means not described here but known in the prior art.

1. A motor-driven hub for electrically driving an axle of a motor vehicle, said motor-driven hub including a hub configured to receive a wheel, the hub being rotatably mounted with respect to a hub carrier about a hub axis, the motor-driven hub including an electric traction machine, the electric machine including an external stator connected to the hub carrier and an internal rotor, the rotation of the rotor of the electric machine being permanently coupled to the rotation of the hub by means of reduction means, the reduction means including a motor pinion gear connected to the rotor of the electric machine and a crown gear connected to the hub, the motor-driven hub also comprising mechanical disk braking means, wherein the reduction means include two stages of reduction and wherein the brake disk is placed on the outside of the hub carrier with respect to the vehicle.

2. The motor-driven hub as claimed in claim 1, wherein a first reduction stage involves the meshing of the motor pinion gear and a cog connected to a countershaft, a second reduction stage involving the meshing of a reduction pinion gear connected to the countershaft with the crown gear connected to the hub.

3. The motor-driven hub as claimed in claim 2, wherein the axis of the countershaft and the axis of the rotor are parallel to the hub axis.

4. The motor-driven hub as claimed in claim 1, wherein the hub carrier includes a spindle about which the hub turns.

5. The motor-driven hub as claimed in claim 1, wherein a casing contains the reduction means and bears the electric machine.

6. The motor-driven hub as claimed in claim 6, wherein the brake disk is placed outside the casing in relation to the vehicle, the brake caliper being rigidly connected to the casing.

7. A motor-driven wheel including a motor-driven hub as claimed in claim 1.

8. A vehicle having at least two motor-driven wheels as claimed in claim 7.

9. The vehicle as claimed in claim 8, wherein two motor-driven wheels are arranged on the rear axle of said vehicle.

10. The vehicle as claimed in claim 9, wherein the hub carriers of the two motor-driven wheels are each rigidly connected to a trailing arm of the rear axle of said vehicle.
